(19) United States
(12) Patent Application Publication
(10) Pub. No.: US 2022/0413096 A1
(43) Pub. Date: Dec. 29, 2022

(54) SYSTEMS AND METHODS FOR TRANSFERRING DATA COMMUNICATION IN A ROTATING PLATFORM OF A LIDAR SYSTEM

(71) Applicant: Argo AI, LLC, Pittsburgh, PA (US)

(72) Inventors: Mark D. ENTWISTLE, New Egypt, NJ (US); Bayard G. GARDINEER, IV, Princeton, NJ (US); William MORDARSKI, Colts Neck, NJ (US); Domenick SALVEMINI, North Plainfield, NJ (US)

(73) Assignee: Argo AI, LLC, Pittsburgh, PA (US)

(21) Appl. No.: 17/898,942

(22) Filed: Aug. 30, 2022

Related U.S. Application Data
(63) Continuation-in-part of application No. 17/690,088, filed on Mar. 9, 2022.
(60) Provisional application No. 63/202,257, filed on Jun. 3, 2021.

(51) Int. Cl. G01S 7/481; G01S 17/86; B60W 60/00

(52) U.S. Cl. CPC G01S 7/481; G01S 17/86; B60W 60/001; B60W 2420/52

(57) ABSTRACT

A system and method are disclosed for providing a bi-directional data communication link within a LIDAR assembly that has a stationary portion attached to an autonomous vehicle and a second portion rotatably connected to the stationary portion. The second portion may include one or more emitting/receiving devices (e.g., lasers) for detecting objects surrounding the autonomous vehicle. A first and second differential capacitive elements may rotatably operate to download data from the second portion to the stationary portion. A third and fourth differential capacitive element may rotatably operate to upload data from the stationary portion to the second portion.

### CROSS-REFERENCE TO RELATED APPLICATIONS

The present application is a continuation-in-part of U.S. patent application Ser. No. 17/690,088, filed Mar. 9, 2022, which claims the benefit of U.S. provisional application Ser. No. 63/202,257 filed Jun. 3, 2021, the disclosures of which are hereby incorporated in their entirety by reference herein.

### TECHNICAL FIELD

The present disclosure relates to Light Detection and Ranging (LIDAR) systems including the transfer of data within a LIDAR system.

### BACKGROUND

LIDAR systems may be used for various purposes. For example, a LIDAR system may be incorporated with a vehicle (such as an autonomous or semi-autonomous vehicle) and may be used to provide range determinations for the vehicle. That is, the vehicle may traverse an environment and may use the LIDAR system to determine the relative distance of various objects in the environment relative to the vehicle. This may be accomplished by emitting light from an emitter device of the LIDAR system into the environment, and detecting return light from the environment (for example, after reflecting from an object in the environment) using a detector device of the LIDAR system. Based on an amount of time that elapses between the time at which the light is emitted and a time at which the return light is detected (for example, a “Time of Flight” of the light), it may be determined how far an object is from the LIDAR system.

Additionally, the one or more emitter devices and one or more detectors may be housed in a rotating portion of the LIDAR system, such that light may be emitted and return light may be detected in various directions around the LIDAR system as the rotating portion of the LIDAR system rotates relative to the fixed portion. This may allow the vehicle to ascertain distance information for objects located within a full 360-degree field of view of the vehicle, rather than only in one direction that the one or more emitter devices and/or one or more detector devices are pointing.

### SUMMARY

A system and method are disclosed for providing a bi-directional data communication link within a LIDAR assembly that has a stationary portion attached to an autonomous vehicle and a second portion rotatably connected to the stationary portion. The second portion may include one or more emitting/receiving devices (e.g., lasers) for detecting objects surrounding the autonomous vehicle. A first printed circuit board including a first set of trace antennas. A second printed circuit board including a second set of trace antennas. The first printed circuit board may be configured to rotate 360-degrees in relation to the second printed circuit board so that the first set of trace antennas and the second set of trace antennas align to provide the bi-directional data link.

A shaft located at a central axis within the LIDAR assembly is connected to the first printed circuit board. The shaft being configured to rotate the first printed circuit board 360-degrees in relation to the second printed circuit board. The first printed circuit board and the second printed circuit board may also be located within an electrically sealed cavity that is configured to enclose one or more cavity currents originating on the shaft from the first set of trace antennas and the second set of trace antennas. A first bearing may also be connected to the shaft and a top side of the electrically sealed cavity and a second bearing may be connected to the center shaft and a bottom side of the electrically sealed cavity. The first bearing and the second bearing may be configured to permit the center shaft and the first printed circuit board to rotate while the electrically sealed cavity and the second printed circuit board remain stationary. It is contemplated, the first set of trace antennas and the second set of trace antennas align to provide a horizontally polarized quarter wave monopole array to provide the bi-directional data link. The first set of trace antennas and the second set of trace antennas may also be configured to align to provide a peak-to-peak frequency that is less than 6 dB.

### BRIEF DESCRIPTION OF THE DRAWINGS

The accompanying drawings are incorporated herein and form a part of the specification.

FIG. 1A depicts an illustrative LIDAR vehicle system.

FIG. 1B depicts a block diagram schematic of the illustrative LIDAR vehicle system.

FIG. 2 depicts an isometric view of a LIDAR assembly.

FIG. 3 depicts a cross-section view of a LIDAR assembly.

FIG. 4 depicts an exemplary cross-section view illustration of a center portion of LIDAR assembly.

FIG. 5 depicts an exemplary illustration of a first antenna array used within the LIDAR assembly.

FIG. 6 depicts an exemplary illustration of a second antenna array used within the LIDAR assembly.

FIG. 7 depicts an exemplary illustration of the first antenna array situated below the second antenna array.

FIG. 8 depicts an exemplary illustration of the first antenna array and the second antenna array during operation.

FIG. 9 depicts an exemplary illustration of the first antenna array and the second antenna array during operation.

FIG. 10 depicts an exemplary illustration of non-contacting ground connections being formed using a plurality of resistive elements.

FIG. 11 depicts an exemplary block diagram of the first antenna array and the second antenna array.

FIG. 12 depicts an exemplary illustration of an optical bi-directional optical data link.

FIG. 13 depicts an exemplary block diagram of the optical bi-directional optical data link.

FIG. 14 depicts an exemplary exploded view of the LIDAR assembly.

FIG. 15 is a cross-sectional exemplary illustration of a bi-directional capacitive data link assembly.

FIG. 16 is a fully assembled exemplary illustration of the bi-directional capacitive data link assembly.

FIG. 17 is an exploded exemplary illustration of the bi-directional capacitive data link assembly.

FIG. 18 is an exemplary view of a differential capacitive element for use within the bi-directional capacitive data link assembly.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art.

Again, LIDAR systems may generally include a rotating portion that houses emitter devices providing range determinations for a vehicle (e.g., Time of Flight data). The range determination data is then transferred from the rotating portion to a fixed portion of the LIDAR system for use by a vehicle's control system (e.g., ECU) or for transmission to an external server. It is contemplated that large amounts of data are downloaded from the rotating portion to the fixed portion. It is also contemplated that data or information (e.g., update files) may be uploaded from the fixed portion to the rotating portion. In addition to data transfer, the light emitting sensors operating within the rotating portion of a LIDAR system typically require significant amounts of electrical power to operate. Lastly, LIDAR systems generally require stability mechanisms that can withstand vehicle vibration during normal operation.

As such, a novel LIDAR structure is disclosed providing concentric features for each of a bearing structure, data uplink, data downlink, power transfer, driver motor, and azimuth detection. It is contemplated the LIDAR subsystems may be constructed to stack radially from a center axis as discussed below.

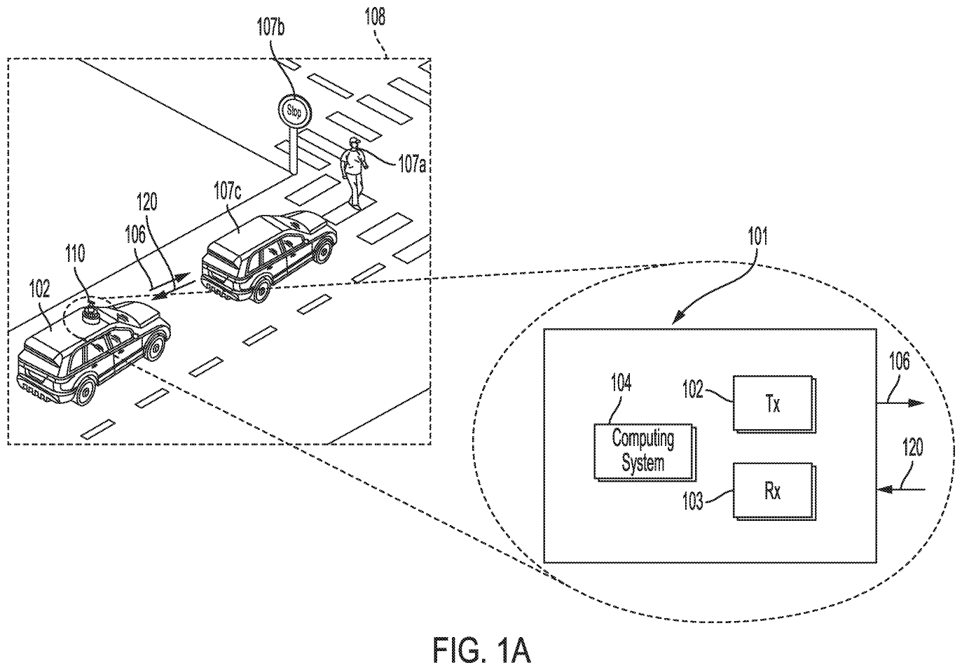

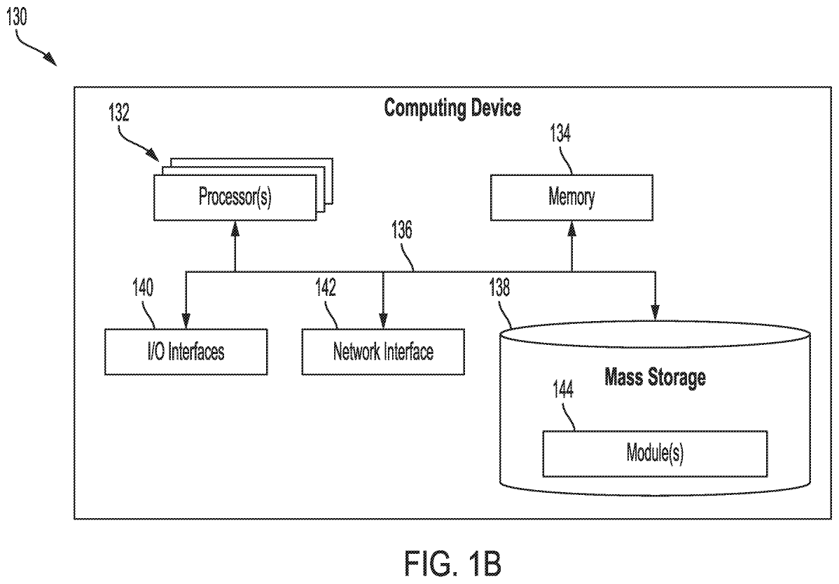

For example, FIG. 1A depicts a schematic of an illustrative LIDAR system 101. In some embodiments, the LIDAR system 101 may include at least one or more emitting devices 102, one or more detector devices 103, and/or one or more computing systems 104. The LIDAR system 101 may be used within a vehicle 105 and include one or more emitter-side optical elements and/or one or more receiver-side optical elements. Additionally, external to the LIDAR system 101 may be an environment 108 that may include one or more objects (for example object 107a and/or object 107b). Hereinafter, reference may be made to elements such as “emitting device,” “detector device,” “circuit,” “controller,” and/or “object,” however such references may similarly apply to multiple of such elements as well.

In some embodiments, an emitting device 102 may be a laser diode for emitting a light pulse (for example, emitted light 106). A detector device 103 may be a photodetector, such as an Avalanche Photodiode (APD), or more specifically an APD that may operate in Geiger Mode (however any other type of photodetector may be used as well). The detector device 103 may be used to detect return light 120 from the environment 108. The return light 120 may be based on the emitted light 106. That is, the emitting device 102 may emit light into the environment 108, the light may reflect from an object in the environment and may return to the LIDAR system 101 as return light 120. It should be noted that the terms “photodetector” and “detector device” may be used interchangeably.

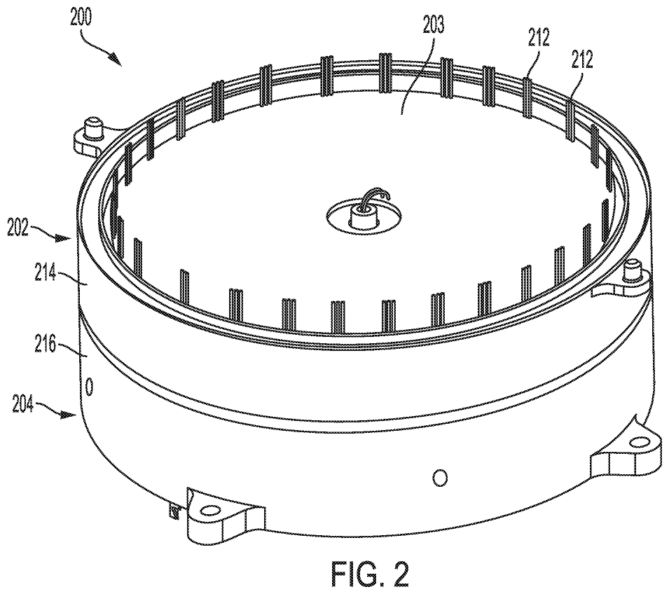

The computing system 104 (which may be referred to as “signal processing elements,” “signal processing systems,” or the like) may be used to perform any of the operations associated with the LIDAR assembly or otherwise. For example, the computing system 104 may be used to perform signal processing on magnetic field data received by one or more sensors (for example, any of the sensors described with respect to FIGS. 2-4 and 9-11, as well as any other sensors described herein) on a LIDAR assembly of the LIDAR system, as well as any other operations associated with the LIDAR system 101. Finally, an object 107a and/or 107b may be any object that may be found in the environment 108 of the LIDAR system 101 (for example, object 107c may be a vehicle and object 107a may be a pedestrian, but any other number or type of objects may be present in the environment 108 as well).

In some embodiments, any of the elements of the LIDAR system 101 (for example, the one or more emitting devices 102, one or more detector devices 103, and/or one or more computing systems 104, as well as any other elements of the LIDAR system 101) may be included within a LIDAR assembly 110 as described herein. The LIDAR assembly 110 may include at least a base, a sensor body, and a motor. The motor may include a stator, a rotor, and a shaft affixed to the rotor. The stator may be configured to drive the rotor in rotation. The motor may be affixed to the base and sensor body such that the motor may be able to rotate the sensor body with respect to the base. The stator may also be affixed to a motor housing, which may be affixed to the base, while the shaft may be affixed to the sensor body (however, in some cases, the sensor body may alternatively be affixed to the rotor instead of being directly affixed to the shaft).

FIG. 1B illustrates details of an exemplary computing system 130 in accordance with one or more embodiments of this disclosure including, for example, computing system 104. The computing system 130 may include at least one processor 132 that executes instructions that are stored in one or more memory devices (referred to as memory 134). The instructions can be, for instance, instructions for implementing functionality described as being carried out by one or more modules and systems disclosed above or instructions for implementing one or more of the methods disclosed above. The processor(s) 132 can be embodied in, for example, a central processing unit (“CPU”), multiple CPUs, a graphical processing unit (“GPU”), multiple GPUs, a tensor processing unit (“TPU”), multiple TPUs, a multi-core processor, a combination thereof, and the like. In some embodiments, the processor(s) 132 can be arranged in a single processing device. In other embodiments, the processor(s) 132 can be distributed across two or more processing devices (e.g., multiple CPUs; multiple GPUs; a combination thereof; or the like).

A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory. Additionally, or as another example, a processor can refer to an integrated circuit (IC), an ASIC, a digital signal processor (DSP), an FPGA, a PLC, a complex programmable logic device (CPLD), a discrete gate or transistor logic, discrete hardware components, or any combination thereof designed or otherwise configured (e.g., manufactured) to perform the functions described herein.

The processor(s) 132 can access the memory 134 by means of a communication architecture 136 (e.g., a system bus). The communication architecture 136 may be suitable for the particular arrangement (localized or distributed) and type of the processor(s) 132. In some embodiments, the communication architecture 136 can include one or many bus architectures, such as a memory bus or a memory controller; a peripheral bus; an accelerated graphics port; a processor or local bus; a combination thereof, or the like. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and/or the like.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory media suitable to retain the desired information and which can be accessed by a computing device.

As an illustration, non-volatile memory can include read-only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory. In addition to storing executable instructions, the memory 134 also can retain data.

Each computing system 130 also can include mass storage 138 that is accessible by the processor(s) 132 by means of the communication architecture 136. The mass storage 138 can include machine-accessible instructions (e.g., computer-readable instructions and/or computer-executable instructions). In some embodiments, the machine-accessible instructions may be encoded in the mass storage 138 and can be arranged in components that can be built (e.g., linked and compiled) and retained in computer-executable form in the mass storage 138 or in one or more other machine-accessible non-transitory storage media included in the computing system 130. Such components can embody, or can constitute, one or many of the various modules disclosed herein. Such modules are illustrated as modules 144. In some instances, the modules may also be included within the memory 134 as well.

Execution of the modules 144, individually or in combination, by at least one of the processor(s) 132, can cause the computing system 130 to perform any of the operations. Each computing system 130 also can include one or more input/output interface devices 140 (referred to as I/O interface 140) that can permit or otherwise facilitate external devices to communicate with the computing system 130. For instance, the I/O interface 140 may be used to receive and send data and/or instructions from and to an external computing device.

The computing system 130 also includes one or more network interface devices 142 (referred to as network interface(s) 142) that can permit or otherwise facilitate functionally coupling the computing system 130 with one or more external devices. Functionally coupling the computing system 130 to an external device can include establishing a wireline connection or a wireless connection between the computing system 130 and the external device. The network interface devices 142 can include one or many antennas and a communication processing device that can permit wireless communication between the computing system 130 and another external device. For example, within a vehicle, between a vehicle and a smart infrastructure system, between multiple vehicles, between two smart infrastructure systems, etc. Such a communication processing device can process data according to defined protocols of one or several radio technologies. The radio technologies can include, for example, 3G, Long Term Evolution (LTE), LTE-Advanced, 5G, IEEE 800.11, IEEE 800.16, Bluetooth, ZigBee, near-field communication (NFC), and the like. The communication processing device can also process data according to other protocols as well, such as communication area network (CAN), vehicle-to-infrastructure (V2I) communications, vehicle-to-vehicle (V2V) communications, and the like. The network interface(s) 512 may also be used to facilitate peer-to-peer ad-hoc network connections as described herein.

It should further be appreciated that the disclosed LiDAR system (e.g., LIDAR system 101) may include alternate and/or additional hardware, software, or firmware components beyond those described or depicted without departing from the scope of the disclosure. More particularly, it should be appreciated that software, firmware, or hardware components depicted as forming part of the computing device 600 are merely illustrative and that some components may not be present or additional components may be provided in various embodiments.

FIG. 2 depicts an isometric view of a LIDAR assembly 200 that may be the same as LIDAR assembly 110 described with respect to FIG. 1, as well as any other LIDAR assembly described herein. In some embodiments, the LIDAR assembly 200 may include at least a first portion 204 and a second portion 202. The first portion 204 may include a first housing 216 and the second portion 202 may include a second housing 214. The first housing 216 and second housing 214 may provide protection for any elements included within the first portion 204 and/or the second portion 202, such as protection from weather conditions, contaminants in the environment, etc. The first portion 204 may be a stator of the LIDAR assembly 200. That is, the first portion 204 may be a portion of the LIDAR assembly 200 that may remain fixed relative to other portions of the LIDAR assembly 200. Likewise, the second portion 202 may be a rotor of the LIDAR assembly 200. That is, the second portion 202 may be a portion of the LIDAR assembly 200 that may rotate relative to other portions of the LIDAR assembly 200, such as the first portion 204 (for example, the stator).

In some embodiments, the second portion 202 includes one or more printed circuit boards (for example, printed circuit board 203, as well as any other printed circuit boards not depicted in the figure). The printed circuit board 203 may represent the sensor body (or a portion of the sensor body) of the LIDAR assembly as described above. That is, the sensor body of the LIDAR assembly may be affixed to the second portion 202 of the LIDAR assembly 200 and may rotate along with the second portion 202 relative to the first portion 204. It is contemplated, the printed circuit board 203 may include any number and/or type of electronic components used by the LIDAR assembly 200. For example, the printed circuit board 203 may include any of the emitting devices 102, one or more detector devices 103, and/or one or more computing systems 104 as described with respect to FIG. 1.

The printed circuit board 203 may also include one or more sensors. In some embodiments, the one or more sensors may include one or more magnetic field sensors 212 that may be used to measure the magnetic fields produced by various magnets (not depicted in the figure) affixed to the first portion 204 of the LIDAR assembly 200. For example, the one or more magnetic field sensors may be Hall sensors. The one or more magnetic field sensors 212 may be arranged in a circular fashion around the circumference of the printed circuit board 203. Any of the elements described as being included in the example printed circuit board 203 illustrated in the figure may be included in any number of other printed circuit boards not depicted in the figure. The one or more sensors may also include any other types of sensors, such as one or more temperature sensors.

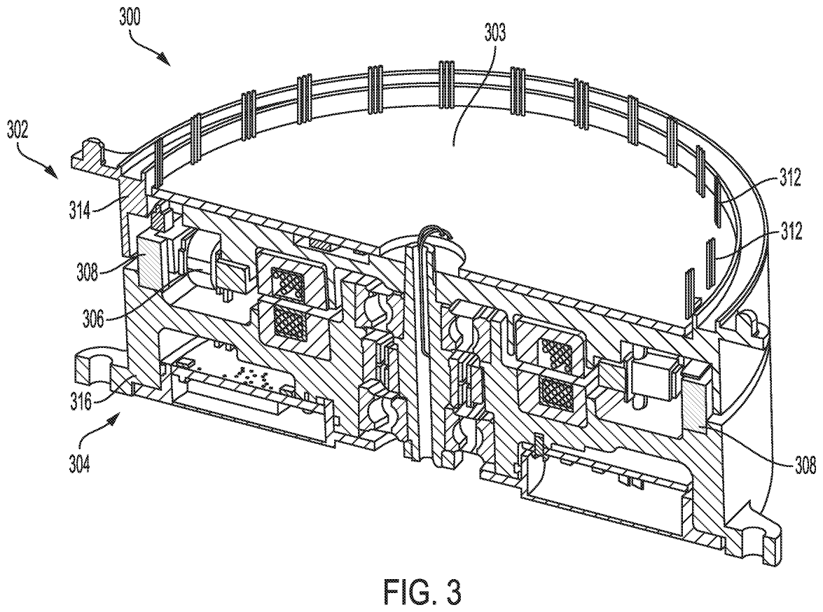

FIG. 3 depicts an exemplary cross-section view of a LIDAR assembly 300. The LIDAR assembly 300 may be the same as LIDAR assembly 200. That is, FIG. 3 may depict the same (or a similar) LIDAR assembly 300 as the LIDAR assembly 200 depicted in FIG. 2, but may present a cross-section view to provide an illustration of elements that may be included within the LIDAR assembly 300. For example, LIDAR assembly 300 may include a first portion 304 and a second portion 302. The first portion 304 may include a first housing 316, and the second portion 302 may include a second housing 314. The LIDAR assembly 300 may also include a printed circuit board 303. As with the printed circuit board 203 depicted in FIG. 2, the printed circuit board 303 may not depict any electronic components, but include any electronic components associated with the LIDAR system. The same may apply to any other printed circuit board depicted and/or described herein. As described above with respect to the LIDAR assembly 200, the first portion 304 may be a stator of the LIDAR assembly 300. That is, the first portion 304 may be a portion of the LIDAR assembly 300 that may remain fixed relative to other portions of the LIDAR assembly 300. Likewise, the second portion 302 may be a rotor of the LIDAR assembly 300. That is, the second portion 302 may be a portion of the LIDAR assembly 300 that may rotate relative to other portions of the LIDAR assembly 300, such as the first portion 304 (for example, the stator).

Through the cross-section view it may be illustrated that the first portion 304 of the LIDAR assembly 300 may further include one or more magnets 308. The one or more magnets 308 may be provided on the first portion 304 in a circular arrangement and may be permanently or removably affixed to the first portion 304. The one or more magnets 308 may be arranged around a circumference of the first portion 304 such that elements of the second portion 302, such as the windings 306, may be provided adjacent to the one or more magnets 308, but located closer to a center point of the LIDAR assembly 300. The one or more magnets 308 may also be arranged such that they may be positioned in line with the one or more magnetic field sensors 312 included on the second portion 302 of the LIDAR assembly 300.

The cross-section view of the LIDAR assembly 300 may also illustrate that the second portion 302 may include one or more windings 306. In some embodiments, the one or more windings 306 may be arranged more internally than the one or more magnets 308 provided on the first portion 304 of the LIDAR assembly 300. The one or more windings 306 may be used to interact with the one or more magnets 308 to produce a rotation of the second portion 302 of the LIDAR assembly 300 relative to the first portion 304 of the LIDAR assembly 300. That is, the LIDAR assembly 300 may operate by providing a current to the one or more windings 306 on the second portion 302 of the LIDAR assembly 300. The current may cause the one or more windings 306 to produce a corresponding magnetic field, which may interact with the magnetic fields produced by the one or more magnets 308. This interaction may cause a rotation of the second portion 302 of the LIDAR assembly 300 relative to the first portion 304. However, this is merely one example of a mechanism by which the rotation of the second portion 302 of the LIDAR assembly 300 may be produced.

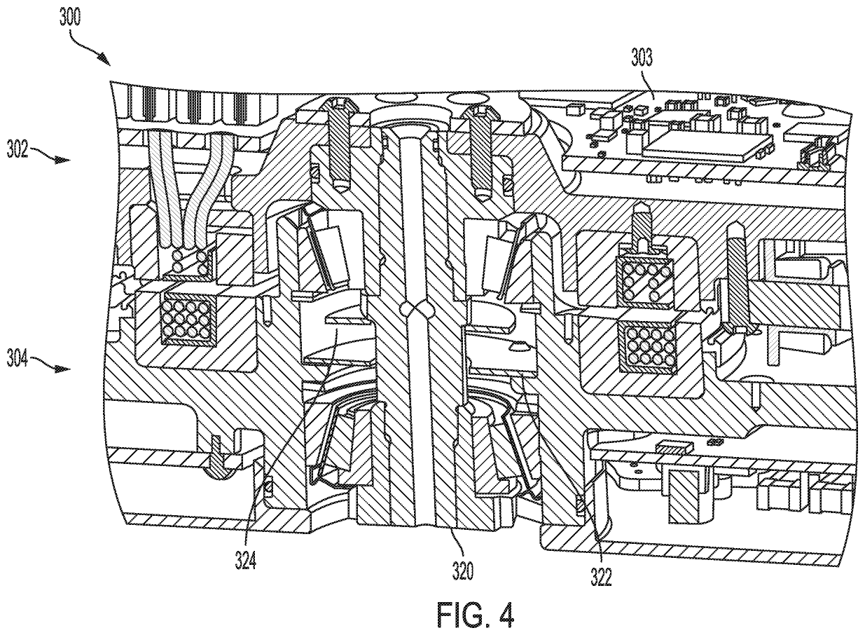

FIG. 4 depicts another exemplary cross-section view illustration of a center portion of LIDAR assembly 300. Again, first portion 304 may be fixed whereas second portion 302 may be rotatable. A center shaft 320 may be positioned and extend between the first portion 304 and second portion 302. A first antenna array 322 may be positioned around center shaft 320 and may be affixed to the first portion. It is contemplated the first antenna array 322 may be affixed to the center shaft 320 using an adhesive or securing mechanism (e.g., screw). The first antenna array 322 may be affixed such that it does not rotate in conjunction with the second portion 302.

It is further contemplated that a second antenna array 324 may further be positioned above or below the first antenna array 322. For instance, FIG. 4 illustrates the second antenna array 324 being positioned above first antenna array 322. The second antenna array 324 may further be affixed to the center shaft 320 or second portion 302. It is contemplated that when attached to the center shaft 320 or second portion 302, the second antenna array 324 may be rotatable in relation to the fixed first antenna array 322.

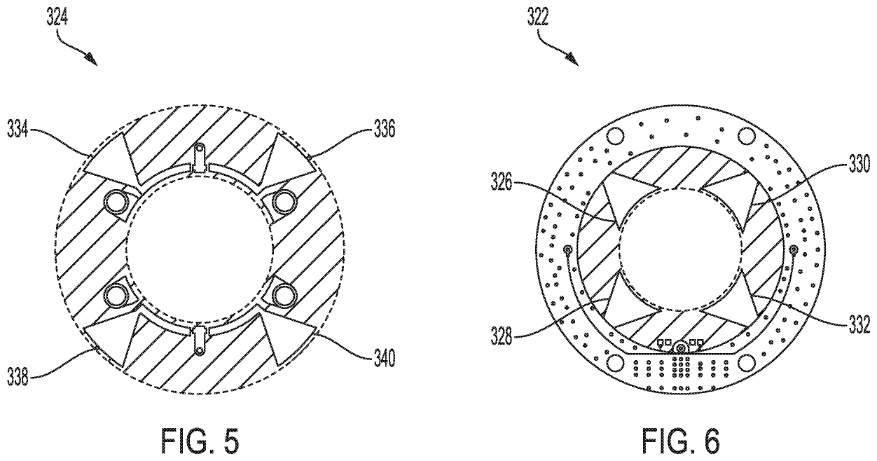

FIGS. 5 and 6 provide exemplary illustrations of the first antenna array 322 and the second antenna array 324 discussed with respect to FIG. 4. As illustrated, the first antenna array 322 may include a plurality of static antennas 326-332. Similarly, the second antenna array 324 may also include a plurality of rotating antennas 334-340. It is contemplated the plurality of static antennas 326-332 and the plurality of rotating antennas 334-340 generate a horizontally polarized quarter wave monopole array that provides data to be transferred between the first antenna array 322 and second antenna array 324.

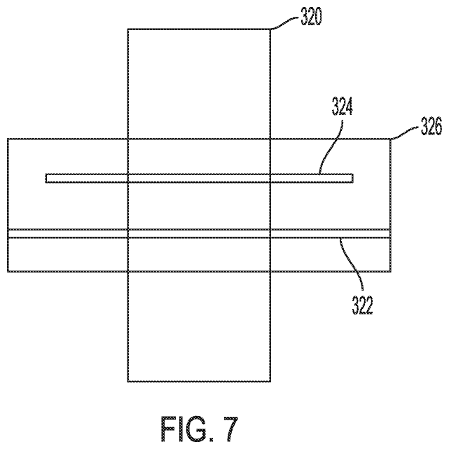

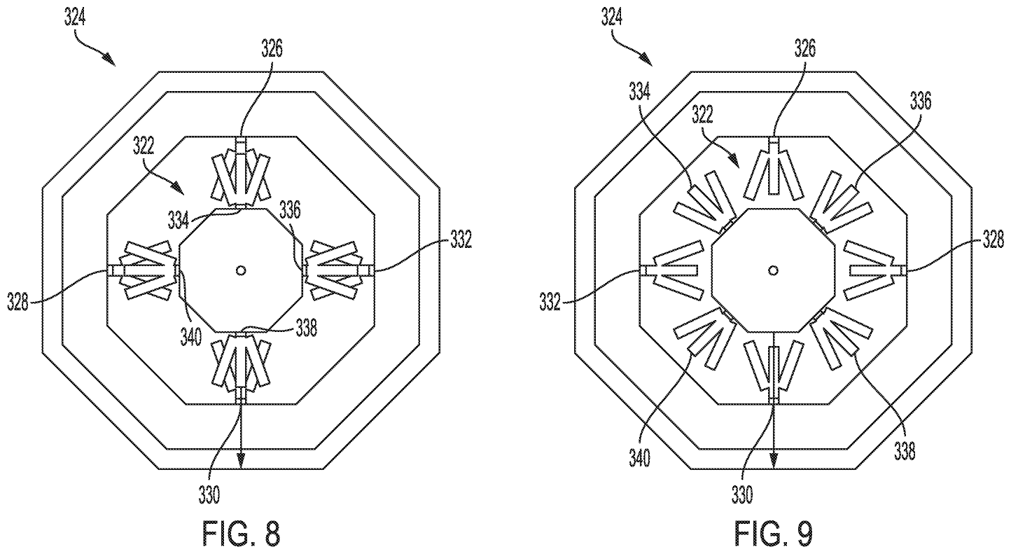

FIG. 7 further depicts the affixed (i.e., non-rotatable) first antenna array 322 situated below the second antenna array 324. FIG. 7 illustrates a gap may exist between the first antenna array 322 and the second antenna array 324. Again, the second antenna array 324 may be attached and be rotated by the center shaft 320. As such, the second antenna array 324 may operably rotate 360-degrees in relation to the first antenna array 322. It is also contemplated an electrically sealed cavity 326 may be included to enclose the cavity currents that originate on the center shaft by the rotating antennas 334-340 and travel to the static antennas 326-332 during operation. The electrically sealed cavity 326 may be constructed using a static housing and bearings that allow center shaft 320 and second antenna array 324 to rotate.

FIGS. 8 and 9 are further exemplary illustrations of the first antenna array 322 and the second antenna array 324 during operation. FIG. 8. Illustrates the plurality of static antennas 326-332 in-line with the plurality of rotating antennas 334-340. It is contemplated that when the static antennas 326-332 are in-line with the plurality of rotating antennas 334-340 there may only be a 3dB peak-to-peak variation in the frequency between the first antenna array 322 and the second antenna array 324. FIG. 8. Illustrates the plurality of static antennas 326-332 at a 45-degree rotation in relation to the plurality of rotating antennas 334-340. When the static antennas 326-332 are at a 45-degree rotation in relation to the plurality of rotating antennas 334-340 there may only be a 2.5 dB peak-to-peak variation in the frequency between the first antenna array 322 and the second antenna array 324. It is contemplated that peak-to-peak variations greater than 6 dB may not allow suitable data transfer (i.e., upload and download) between the first antenna array 322 and the second antenna array 324. Instead, peak-to-peak variations would preferably be maintained below 4 dB.

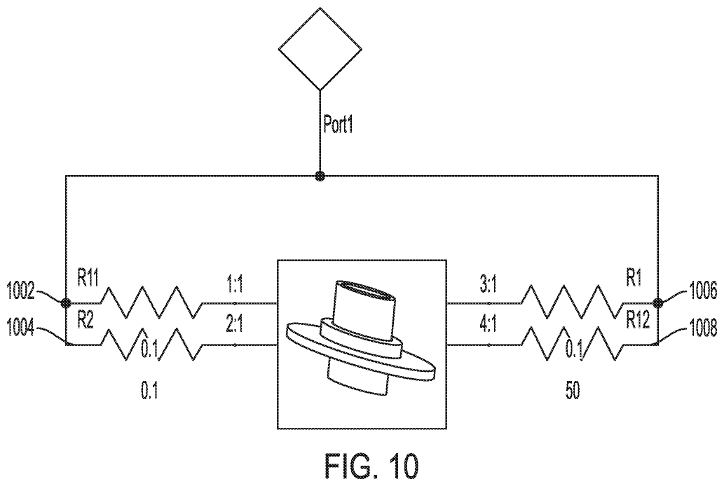

It is also contemplated that non-contacting ground connections may be employed to shunt the cavity currents from the bearing assemblies used to allow rotation of the center shaft 320. For instance, FIG. 10 illustrates the non-contacting ground connections being formed using a plurality of resistive elements 1002-1008. As illustrated, the resistive elements 1002-1008 may be constructed in a parallel to shunt the current from the bearings. It is contemplated the net parallel impedance of the resistive elements 1002-1008 between static ground and the rotating ground may be operably between 8 ohms and 3 ohms. It is also contemplated the non-contacting ground connections on the first portion 304 (i.e., static portion) may be assembled using a flex cable and the non-contacting ground connections on the second portion 302 (i.e., rotating portion) may be connected using a coaxial cable. The connections may permit a 6-7 dB signal that provides a variation with the shaft angle.

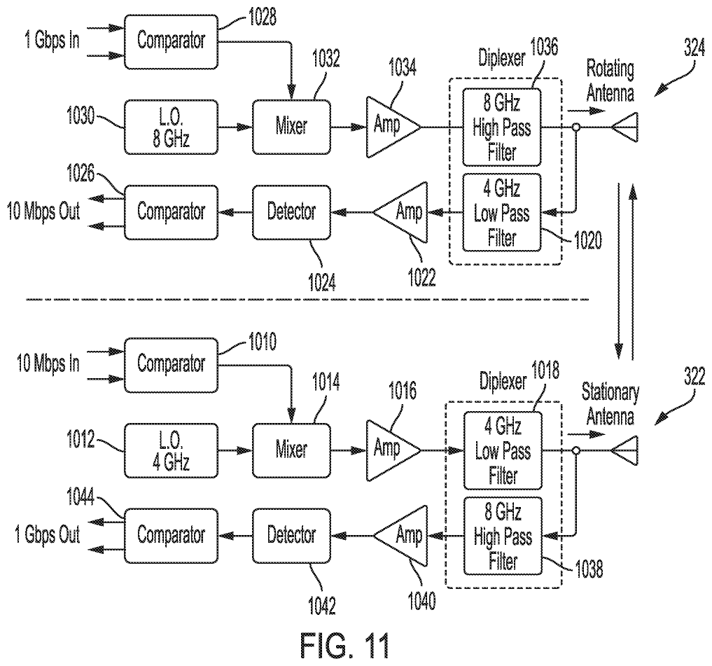

FIG. 11 illustrates a block diagram of the first antenna array 322 (i.e., stationary antenna array) and the second antenna array 324 (i.e., rotating antenna array). Again, the first antenna array 322 (i.e., stationary antenna array) and the second antenna array 324 may be operable to provide a bi-directional communication link. The link is operable to allow data and information to be transmitted or downloaded from the second antenna array 324 to the first antenna array 322. And the link is operable to allow data and information to be transmitted or uploaded from the first antenna array 322 to the second antenna array 324. Uploaded data/information may include software updates, parameters or settings used within processor(s), memory, or sensor units located within portion 302. Downloaded data/information may include data acquired relating to objects surrounding the LIDAR system.

As illustrated, the first antenna array 322 may be operable to transmit or upload data to the second antenna array 324 at a speed of 10-50 Mbps. The upload data may be received by the first antenna array 322 at a comparator module 1010. A mixer circuit 1014 may mix the incoming data from comparator with a local oscillator (“L.O.”) frequency driver 1012 (e.g., 4 GHz). The mixer circuit 1014 may then provide the mixed data to an amplifier circuit 1016 which is then passed through a diplexer circuit that includes a low pass filter 1018. As illustrated the low pass filter 1018 may be operating at 4 GHz. The upload data is then transmitted (i.e., uploaded) to the second antenna array 324. Once received, the upload data is provided through low pass filter 1020 to amplifier 1022, and then to a detector circuit 1024. Lastly, the upload data is provided to a comparator 1026 that may operate at same speed as comparator 1010 (e.g., 10 Mbps).

Conversely, download data may be transmitted at speeds of 1 Gbps (i.e., 8 GHz). The download data may be received by the second antenna array 324 at a comparator module 1028. A mixer circuit 1032 may mix the incoming data from comparator with a L.O. frequency driver 1030 (e.g., 4 GHz). The mixer 1032 may then provide the mixed data to an amplifier circuit 1034 which is then passed through a diplexer circuit that includes a high pass filter 1036. As illustrated the high pass filter 1036 may be operating at 8 GHz. The download data is then transmitted (i.e., downloaded) to the first antenna array 322. Once received, the download data is provided through high pass filter 1038 to amplifier circuit 1040, and to detector circuit 1042. Lastly, the download data is provided to a comparator 1044 that may operate at the same speed as the comparator module 1028 (e.g., 1 Gbps).

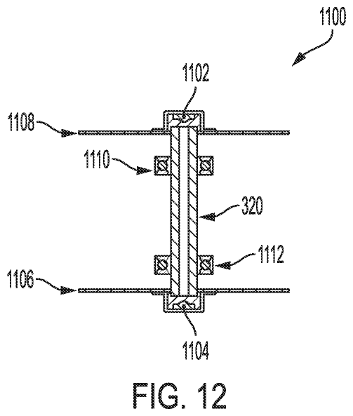

FIG. 12 illustrates an alternative embodiment where a bi-directional optical data link 1100 may be used to transmit electrically encoded data optically between the first portion 304 (i.e., static portion) and the second portion 302 (i.e., rotating portion). It is contemplated, the optical data link 1100 may be used together with the first antenna array 322 and second antenna array 224. Or, the optical data link 1100 may be used in place of the first antenna array 322 and second antenna array 224. As illustrated, the center shaft 320 may be constructed to include a free-space aperture (e.g., hollow portion) through the middle of the center shaft thereby allowing data transfer by light transmission between a first optical transceiver 1102 and a second optical transceiver 1104. It is contemplated the free-space aperture may be constructed along the axis of rotation of the center shaft 320.

As illustrated the shaft 320 may be included within the second portion 302 and may be connected to a rotating printed circuit board (PCBA) operable to transmit and receive data optically using optical transceiver 1102. A stationary PCBA 1106 may be included within first portion 304 and may be connected to the second optical transceiver 1104. One or more bearing assemblies 1110, 1112 may further be connected and operably allow center shaft 320 to rotate.

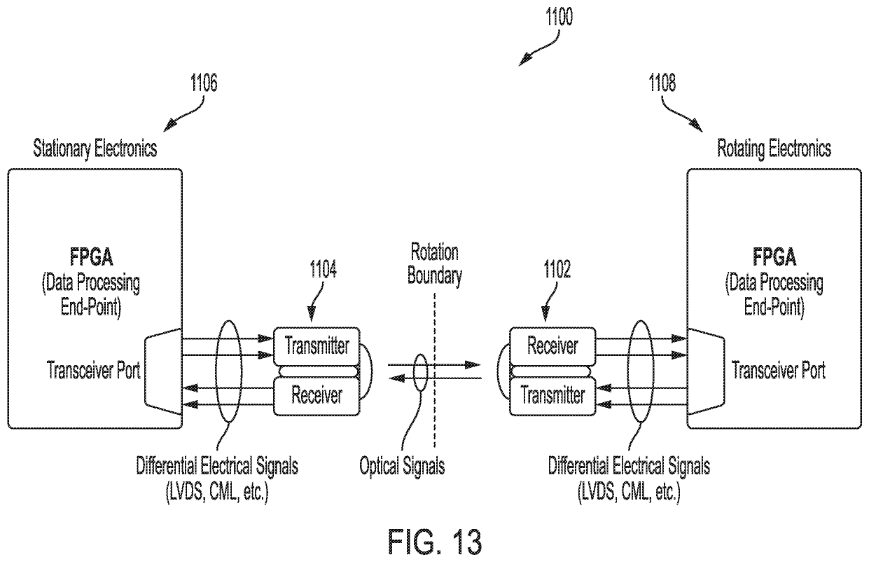

FIG. 13 is another exemplary block diagram of the bidirectional data optical data link 1100 used to transmit electrically encoded data optically between the first portion 304 (i.e., static portion) and the second portion 302 (i.e., rotating portion). Again, a rotating printed circuit board (PCBA) 1108 may operably transmit and receive data optically using optical transceiver 1102. A stationary PCBA 1106 may be included within first portion 304 and may be connected to the second optical transceiver 1104. As further illustrated, transceiver 1104 and transceiver 1102 may include both a transmitter and receiver operable to transmit and receive optical signals along a rotation boundary within the center shaft 320.

It is contemplated that the PCBA 1108, 1106 may designed using an field programable gate array (“FPGA”) operable to receive and transmit differential electrical signals (e.g., Low-voltage differential signal or “LVDS”, current mode logic or “CIVIL”). It is also contemplated optical data transfer may be insensitive to the relative angular rotation between the first optical transceiver 1102 and the second optical transceiver 1104. The baseband electrical signal may also be converted into an optical pulse train for transfer across the rotating boundary of the center shaft 320. The baseband electrical signal may also be operable to encode the data to be transferred. Upon receiving an optical pulse train, transceiver 1102 or transceiver 1104 may convert the pulse train into an electrical signal which encodes the data to be transferred. Transceiver 1102 and transceiver 1104 may also be operable to simultaneously transfer data in both directions on axis from either transceiver 1104 or transceiver 1102. For instance, transceiver 1102, 1104 may be designed using a Broadcom AFBR-FS13B25 optical transceiver.

The PCBA 1106 or 1108 may also provide direction connections at each end-point using hardware, electrical, and protocol interfaces. The mechanical mounting of each transceiver 1102, 1104 may be designed to maintain optical alignment along the rotational boundary axis to help aid in precluding contamination (e.g., dust, dirt, etc.) of the optical surfaces. Lastly, it is contemplated the bidirectional data optical data link 1100 may be advantageous as it is less susceptible to electro-mechanical (EM) interference.

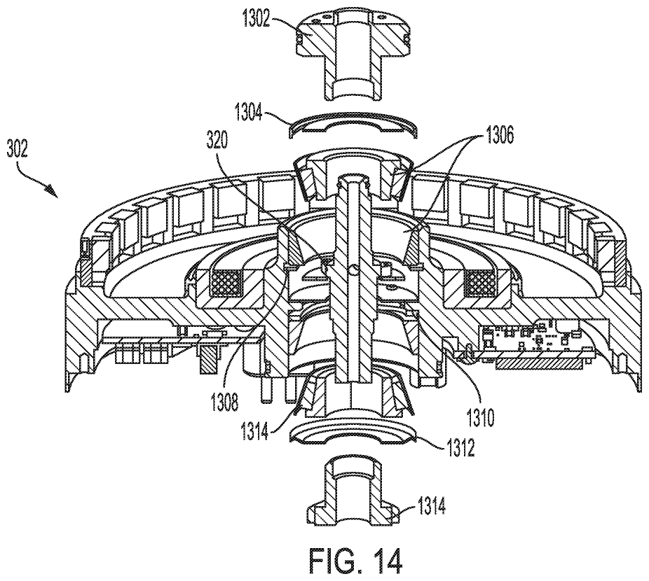

FIG. 14 is an exemplary exploded view of the LIDAR assembly 300 discussed with reference to FIG. 3 above. As illustrated an upper bearing flange 1302 and lower bearing flange 1303 may be used to attach bearing seal 1304 and bearing seal 1312 to a pair of tapered roller bearings 1306, 1314. Flange 1302, 1303 may also be operable to stabilize and maintain center shaft 320 within the LIDAR assembly 300. Roller bearings 1306, 1314 may also allow upper portion 302 and center shaft 320 to rotate smoothly.

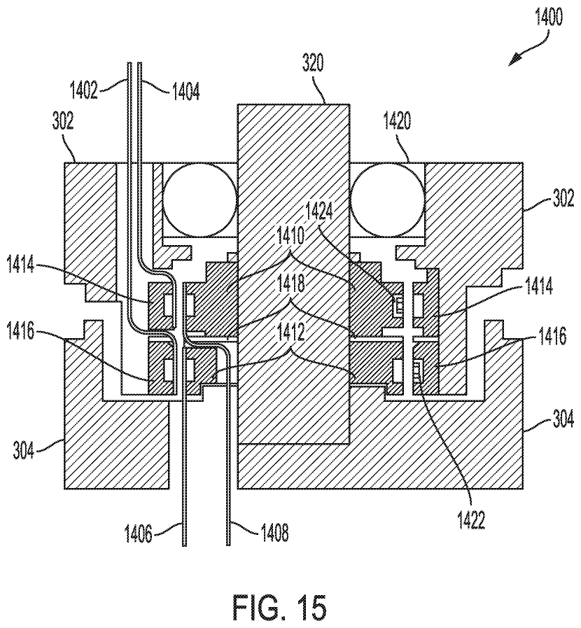

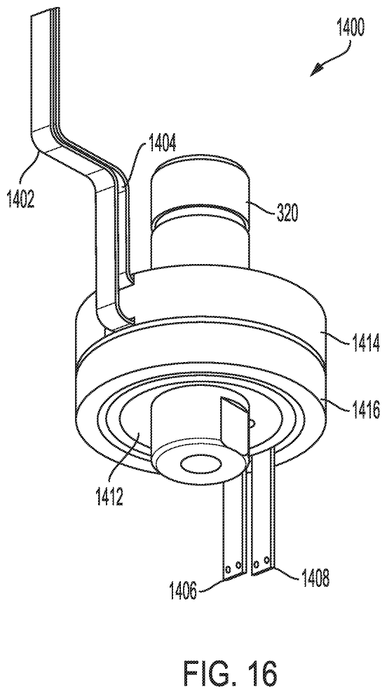

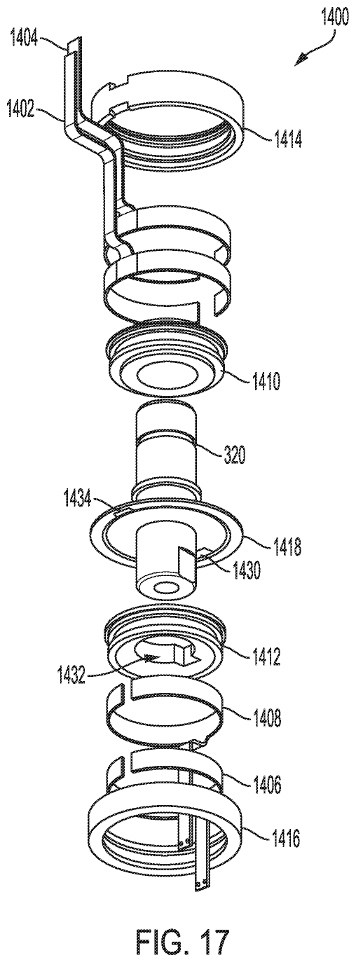

FIG. 15 is an exemplary cross-sectional view of a bi-directional capacitive data link assembly 1400. FIG. 16 is a 3-dimensional view of the bi-directional capacitive data link assembly 1400 fully assembled. Lastly, FIG. 17 is an exploded view of the bi-directional capacitive data link assembly 1400. It is contemplated that the bi-directional capacitive data link assembly 1400 may be incorporated within LIDAR assembly 300 described above and may include a center shaft 320, a stationary first portion 304 (or first portion 204), and a rotating second portion 302 (or second portion 202). According to some aspects, LIDAR assembly 300 may be one example of a sensor in which data link assembly 1400 incorporated. It can be appreciated that any mechanical sensor with moving components may benefit from the incorporation of data link assembly 1400 to provide improved connectivity (e.g., both uplink and downlink data transfer capabilities) and improved serviceability and maintenance.

As shown in FIGS. 15-17, the assembly 1400 may include four capacitive elements 1402-1408 operable to provide a bi-directional data link between the stationary first portion 304 and rotating second portion 302. As illustrated, capacitive elements 1402 and 1404 may associated with the second portion 302 and capacitive elements 1406 and 1408 may be associated with the first portion 304. One or more bearing assemblies 1420 may further be connected to the center shaft to allow capacitive elements 1402, 1404 to rotate relative to capacitive elements 1406, 1408. As such, when the second portion 302 rotates relative to the first portion 304, capacitive elements 1402, 1404 may likewise rotate relative to capacitive elements 1406, 1408.

As further shown, an upper rotating ring 1414 and lower rotating ring 1416 may be positioned and physically attached to the second portion 302. And an upper stationary ring 1410 and lower stationary ring 1412 may be positioned and physically attached to the first portion 304. The upper rotating ring 1410 and the lower rotating ring 1412 may be designed to securely hold the capacitive element 1404 and capacitive element 1402, respectively. Likewise, the upper stationary ring 1414 and the lower stationary ring 1416 may be designed to hold the capacitive element 1402 and capacitive element 1406, respectively.

Capacitive element 1402 may operate as a downlink transmission (Tx) feed where data is being transmitted to capacitive element 1404 that is operating as a respective stationary downlink reception (Rx) feed. Together capacitive element 1402 (i.e., downlink Tx feed) and capacitive element 1406 (i.e., downlink Rx Feed) may operate as the Tx/Rx pair for data downlink transmissions. As described above, downloaded data/information may include data acquired relating to objects surrounding the LIDAR system or any other information which may be acquired/stored, for example, within printed circuit board 303 having one or more processors 132, memory 134, or mass storage 138. It is contemplated the downlink data transmission rate may be at least 1 gigabyte/second such that whatever voltage is pulsed from the transmit side to the receiver side.

Similarly capacitive element 1404 may operate as an uplink reception (Rx) feed where data is being transmitted from capacitive element 1408 that is operating as the respective stationary uplink transmission (Tx) feed. Together capacitive element 1404 (i.e., uplink Rx feed) and capacitive element 1408 (i.e., uplink Tx feed) may operate as the Tx/Rx pair for data uplink transmissions. Again, it is contemplated that data/information (e.g., update files) may be uploaded from the fixed first portion 304 to the rotating second portion 302. Such uploaded data/information may include software updates, parameters or settings used within processor(s), memory, or sensor units located within portion 302.

It is contemplated that rotating rings 1414, 1416 and stationary rings 1410, 1412 may be constructed using a dielectric material (e.g., polystyrene) to prevent electrical coupling with portions of the LIDAR assembly 300 which may be assembled using a metallic material (e.g., shaft 320). Rings 1410-1416 may be designed using a dielectric material to minimize unwanted coupling which may degrade the capacitive transmission of data between capacitive elements 1402 and 1406 (i.e., data downlink transmissions) or capacitive elements 1404 and 1408 (i.e., data uplink transmissions).

Use of a dielectric material may also minimize additional undesired effects such as unwanted electric fields which may leach or degrade signal transmission between capacitive elements 1402 and 1406 (i.e., data downlink transmissions) or capacitive elements 1404 and 1408 (i.e., data uplink transmissions. It is additionally contemplated the material of the rotating rings 1414, 1416 and stationary rings 1410, 1412 may be selected to provide a desired stability over a wide range of temperatures (e.g., extreme heat and cold).

Again, capacitive elements 1402 and 1406 operate together to provide data downlink transmissions and capacitive elements 1404 and 1408 operate together to provide data uplink transmissions. Each pair of capacitive elements (i.e., elements 1402/1406 and elements 1404/1408) are designed with LIDAR assembly to have specific spacing and concentricity. For instance, it is contemplated when capacitive element is placed within rotating ring 1414 and capacitive element 1408 is placed within stationary ring 1410 there may exist a given gap or distance between the associated capacitive elements. Again, either uplink or downlink data transmission is achieved by capacitive communication between each pair of capacitive elements (i.e., elements 1404/1408 and 1402/1406).

Based on the overall packaging dimensions of LIDAR assembly 300, the manufacturing tolerances of the LIDAR assembly 300, or potential shock and vibration between the stationary first portion 304 and rotating second portion 302, the distance between the capacitive elements 1402-1408 can be adjusted. The distance or gap between the capacitive elements 1402-1408 may preferably be less than 1 millimeter (e.g., 0.8 millimeters) so as to provide sufficient separation and ensure elements 1404 and 1408 or elements 1402 and 1406 do not come in contact or collide. But the distance or gap cannot be too large between elements 1404 and 1408 or elements 1402 and 1406 that sufficient capacitance is not maintained and the data signal is not adequately transmitted.

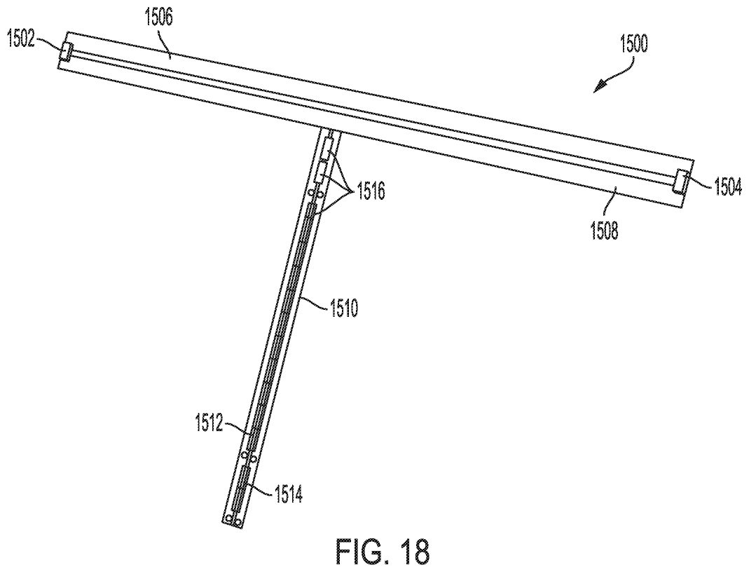

FIG. 18 is an exemplary differential capacitive element 1500 configured as a flexible printed circuit. It is contemplated the differential capacitive element 1500 may be configured using a Kapton Flex Circuit technology. However, other flexible printed circuit technologies may likewise be employed. The capacitive element 1500 may be representative of each capacitive elements 1402-1408 illustrated in FIGS. 15-17.

Capacitive element 1500 may include a positive capacitive portion 1506 (p) and a negative capacitive portion 1508 (n) that are rolled in a circular manner to fit within the stationary first portion 304 or rotating second portion 302 of the LIDAR assembly 300. It is contemplated that capacitive element 1500 may be flexibly designed to be positioned in a circular manner center around shaft 320. For instance, capacitive element 1506 may be any one of the capacitive elements 1402-1408. It is therefore contemplated four capacitive elements 1500 may be used to form the bi-directional data link illustrated in FIG. 15. For instance, two capacitive elements 1500 would be used to form the Tx/Rx pair for the data uplink transmissions (i.e., elements 1404 and 1408). Likewise, two capacitive elements 1500 would also be used to form the Tx/Rx pair for the data downlink transmissions (i.e., elements 1402 and 1406).

The capacitive element 1500 may include a feed line 1510 extending from capacitive portions 1506, 1508. The feed line 1510 may be designed using transmission line or strip line technology. It is contemplated the feed line 1510 may be designed so as to extend away from the rings 1410-1416 (as shown in FIG. 15) toward the stationary first portion 304 or rotating second portion 302. The feed line 1510 may include a positive feed 1512 electrically coupled to capacitive portion 1506 and a negative feed 1514 electrically coupled to capacitive portion 1508. The feed line 1510 is designed so that the positive and negative feeds 1512, 1514 may be electrically connected to a printed circuit board within either the stationary first portion 304 or rotating second portion 302. Rectangular traces 1516 may be located on one or both sides of the feed line 1510. These traces 1516, along with the thickness of the feeds 1512, 1514, are designed to provide a given impedance to improve signal integrity.

The feed line may also be designed to be positioned through a circular divider 1418 (shown in FIGS. 15 and 17) separating uplink data transmission ring set (i.e., rings 1410, 1414) and the downlink data transmission ring set (i.e., rings 1412, 1416). For instance, the capacitive element 1402 (which is connected to circuit board within rotating second portion 302) extends through a gap 1430 in the divider 1418 to be secured within ring 1416. Likewise, capacitive element 1408 (which is connected to circuit board within stationary first portion 304) extends through a gap 1434 in the divider 1418 to be secured within ring 1410.

Capacitive element 1500 may include one or more termination resistive elements 1502, 1504 when used as one of the transmission capacitive elements shown in FIG. 15 (i.e., elements 1402 or 1408). The resistive elements 1502, 1504 may be designed to have a given resistive value (e.g. 200 Ohms). When installed within rings 1410 or 1416 (i.e., transmission elements 1402 or 1408), the resistive elements 1502, 1504 may then be electrically connected in parallel so that the termination provides a 100-Ohm impedance circuit. The 100-Ohm circuit would then be operable to provide improved fidelity and would prevent any reflection of the signal back towards the source. In other words the resistive elements 1502, 1504 ensure any residual signal travelling to one end of portions 1506, 1508 is terminated in the right impedance to eliminate any reflections. It is also contemplated that a small gap or non-conductive material would separate the resistive elements 1502, 1504 to ensure they are not electrically in contact.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable mediums having computer readable program code embodied thereon.

Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (erasable programmable read-only memory (EPROM) or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A system for providing a bi-directional data link within a LIDAR assembly, comprising:
a stationary assembly configured to mount to an autonomous vehicle;
a rotating assembly for rotation about an axis and relative to the stationary assembly;
one or more emitting devices and receiving devices mounted to the rotating assembly and collectively configured to detect objects external to the autonomous vehicle;
a stationary uplink feed and a stationary downlink feed connected to a first printed circuit board (PCB) located within the stationary assembly;
a rotating uplink feed and a rotating downlink feed connected to a second PCB located within the rotating assembly;
wherein the rotating uplink feed is positioned a first predefined distance from the stationary uplink feed allowing for capacitive transmission of uplink data from the first PCB to the second PCB; and
wherein the rotating downlink feed is positioned a second predefined distance from the stationary downlink feed allowing for capacitive transmission of downlink data from the second PCB to the first PCB.

2. The system of claim 1, further comprising:
a shaft extending from a base along the axis;
an upper stationary ring with a first outer diameter surface, the upper stationary ring being affixed to the shaft and the stationary uplink feed being assembled to the first outer diameter surface; and
a lower stationary ring having a second outer diameter surface, the lower stationary ring being affixed to the shaft and the stationary downlink feed being assembled to the second outer diameter surface.

3. The system of claim 2, further comprising:
an upper rotating ring having a third outer diameter surface, the upper rotating ring being affixed to the rotating assembly and the third outer diameter surface being assembled to the rotating uplink feed; and
a lower rotating ring having a fourth outer diameter surface, the lower rotating ring being affixed to the rotating assembly and the rotating downlink feed being assembled to the fourth outer diameter surface.

4. The system of claim 3, wherein the rotating assembly rotates the upper rotating ring and the lower rotating ring in relation to the upper stationary ring and the lower stationary ring.

5. The system of claim 4, wherein a divider is affixed to the shaft to separate the upper stationary ring from the lower stationary ring and the upper rotating ring from the lower rotating ring.

6. The system of claim 4, wherein the upper stationary ring, the lower stationary ring, the upper rotating ring, and the lower rotating ring are constructed using a dielectric material.

7. The system of claim 6, wherein the dielectric material is polystyrene.

8. The system of claim 1, wherein the first predefined distance prevents the rotating uplink feed and the stationary uplink feed from coming into electrical contact.

9. The system of claim 1, wherein the second predefined distance prevents the rotating downlink feed and the stationary downlink feed from coming into electrical contact.

10. The system of claim 1, wherein the stationary uplink feed, the stationary downlink feed, the rotating uplink feed, and the rotating downlink feed are constructed as a flexible printed circuit.

11. The system of claim 10, wherein the flexible printed circuit is constructed as a differential capacitive element.

12. The system of claim 11, wherein the flexible printed circuit include a positive capacitive portion with a first thickness and a first width and a negative capacitive portion with a second thickness and a second width.

13. The system of claim 12, wherein a pair of resistive elements are located at both ends of the flexible printed circuit of the stationary uplink feed and the rotating downlink feed.

14. The system of claim 13, wherein the pair of resistive elements have a predefined endpoint termination resistance for terminating an electrical signal being transmitted along the positive capacitive portion and the negative capacitive portion.

15. The system of claim 14, wherein the flexible printed circuit includes a feed line with a positive feed trace connected to the positive capacitive portion and a negative feed trace connected to the negative capacitive portion.

16. The system of claim 15, wherein the feed line is designed as 100-ohm differential feed-line connected to the positive capacitive portion and the negative capacitive portion as an integrated pigtail.

17. A method for providing a bi-directional data link within a LIDAR assembly, comprising:
rotating an uplink capacitive element a first predefined distance from a stationary uplink capacitive element;
rotating a downlink capacitive element a second predefined distance from a stationary downlink capacitive element;
transmitting a downlink data from the downlink capacitive element to the stationary downlink capacitive element, wherein the downlink data is transmitted from a first printed circuit board assembly located within a rotating portion of the LIDAR assembly and received by a second printed circuit board assembly located within a stationary portion of the LIDAR assembly; and
transmitting an uplink data from the stationary uplink capacitive element to the uplink capacitive element, wherein the uplink data is transmitted from the second printed circuit board assembly and received by the first printed circuit board assembly.

18. The method of claim 17, further comprising: spacing the uplink capacitive element from the stationary uplink capacitive element by a first predefined gap to prevent the uplink capacitive element from electrically contacting the stationary uplink capacitive element.

19. The method of claim 18, further comprising: spacing the downlink capacitive element from the stationary downlink capacitive element by a second predefined gap to prevent the downlink capacitive element from electrically contacting the stationary downlink capacitive element.

20. A data communication element for use within a LIDAR system, comprising:
a differential capacitive element including a positive capacitive portion and a negative capacitive portion;
a first termination element located at a first end of the differential capacitive element, the first termination element being coupled across the positive capacitive portion and the negative capacitive portion, and the first termination element operating to reduce a first reflection when an electrical signal approaches the first end;
a second termination element located at a second end of the differential capacitive element, the second termination element being coupled across the positive capacitive portion and the negative capacitive portion, and the second termination element operating to reduce a second reflection when the electrical signal approaches the second end;
a differential feed line extending from the differential capacitive element, the differential feed line having a positive feed line and a negative feed line, wherein the positive feed line is electrically connected to the positive capacitive portion and the negative feed line is electrically connected to the negative capacitive portion; and
wherein the differential capacitive element is circularly arranged such that a predefined distance exists between the first termination element and second termination element.
